(19) United States
(12) Patent Application Publication
(10) Pub. No.: US 2024/0415202 A1
(43) Pub. Date: Dec. 19, 2024

(54) METHOD FOR MANUFACTURING A HEATING ASSEMBLY FOR AN AEROSOL-GENERATING DEVICE

(71) Applicant: PHILIP MORRIS PRODUCTS S.A., Neuchatel (CH)

(72) Inventor: Wei Zhang, Guangdong (CN)

(21) Appl. No.: 18/700,834

(22) PCT Filed: Nov. 5, 2021
(86) PCT No.: PCT/CN2021/129057

§ 371 Date: Apr. 12, 2024

(30) Foreign Application Priority Data
Oct. 22, 2021 (WO) PCT/CN2021/125824
Oct. 25, 2021 (WO) PCT/CN2021/126067
Oct. 25, 2021 (WO) PCT/CN2021/126085
Oct. 25, 2021 (WO) PCT/CN2021/126120
Oct. 25, 2021 (WO) PCT/CN2021/126197

(51) Int. Cl. A24F 40/70; A24F 40/465; A24F 40/50

(52) U.S. Cl. CPC A24F 40/70; A24F 40/465; A24F 40/50

(57) ABSTRACT

The invention relates to a method for manufacturing a heating assembly for an aerosol-generating device, the method comprising the steps of: providing a first substrate layer, the first substrate layer being an electrically isolating substrate layer, arranging a heating element on the first substrate layer, thereby forming a heating layer, providing a second substrate layer, the second substrate layer being an electrically isolating substrate layer, arranging electrical contacts of a temperature sensor on the second substrate layer, thereby forming a temperature sensor layer, arranging the temperature sensor layer on the heating layer.

The present invention relates to a method for manufacturing a heating assembly for an aerosol-generating device. The present invention further relates to a method for manufacturing an aerosol-generating device comprising the heating assembly.

It is known to provide an aerosol-generating device for generating an inhalable vapor. Such devices may heat an aerosol-forming substrate contained in an aerosol-generating article without burning the aerosol-forming substrate. The aerosol-generating article may have a rod shape for insertion of the aerosol-generating article into a cavity of the aerosol-generating device.

A heating element of a heating assembly is typically arranged in or around the cavity for heating the aerosol-forming substrate once the aerosol-generating article is inserted into the cavity of the aerosol-generating device.

Heat produced by the heating element may inadvertently be dissipated to components of the device that are not intended to be heated. Generally, heat dissipation away from the cavity may cause heat losses within the cavity resulting in a less efficient heating.

An excess amount of energy may be required to heat the cavity to a desired temperature. At the same time, the heating element has to be electrically isolated from the cavity to prevent a short-circuit of the heating element.

It would be desirable to provide a method of manufacturing a heating assembly for an aerosol-generating device that may reduce heat losses from the cavity. It would be desirable to provide a method of manufacturing a heating assembly that may reduce heating up of the outer housing of the device to be grasped by a user.

It would be desirable to provide a method of manufacturing a heating assembly that may provide effective thermal insulation.

It would be desirable to provide a method of manufacturing for a heating assembly that may provide thermal insulation at low manufacturing costs. It would be desirable to provide a method of manufacturing for a heating assembly that may electrically isolate a heating element of the heating assembly from the cavity.

It would be desirable to provide a method of manufacturing for a heating assembly with optimized thermal insulation and optimized electrical isolation at low manufacturing costs. It would be desirable to provide a method of manufacturing for a heating assembly that may provide thermal insulation and electrical isolation at the same time.

It would be desirable to provide an easy method of manufacturing a heating assembly with optimized thermal and electrical insulation including different layers of electrically isolating substrate.

According to an embodiment of the present invention a method for manufacturing a heating assembly for an aerosol-generating device is provided. The method may comprise the steps of providing a first substrate layer, the first substrate layer being an electrically isolating substrate layer. The method for manufacturing the heating assembly may comprise a step of arranging a heating element on the first substrate layer, thereby forming a heating layer. The method for manufacturing the heating assembly may comprise a step of providing a second substrate layer, the second substrate layer being an electrically isolating substrate layer. The method may comprise the steps of arranging electrical contacts of the temperature sensor on the second substrate layer, thereby forming a temperature sensor layer. The method for manufacturing the heating assembly may furthermore comprise the step of arranging the temperature sensor layer on the heating layer.

Another embodiment of the present invention provides a method for manufacturing a heating assembly for an aerosol-generating device. The method comprises the method step of providing a first substrate layer, the first substrate layer being an electrically isolating substrate layer. Furthermore, the method comprises the step of arranging a heating element on the first substrate layer, thereby forming a heating layer. The method also comprises the step of providing a second substrate layer, the second substrate layer being an electrically isolating substrate layer. The method for manufacturing the heating assembly also includes the step of arranging electrical contacts of a temperature sensor on the second substrate layer, thereby forming a temperature sensor layer. Furthermore, the method comprises the step of arranging the temperature sensor layer on the heating layer.

By providing a separate heating layer with the heating element and a temperature sensor layer with electrical contacts of the temperature sensor, manufacturing of the heating assembly is made easier. The method of manufacturing the heating assembly according to the invention allows an arranging of the heating element on the first substrate layer. Separately from the heating layer, electrical contacts are arranged on the second substrate layer for forming the temperature sensor layer. This allows an easy manufacturing of the heating assembly with different electrically isolating substrate layers. This may allow the easy manufacturing of the heating assembly wherein the heating element and electrical contacts of a temperature sensor are located on different electrically isolating substrate layers. This may enable an electrical isolation of the heating element from the other components of the heating assembly. This may allow thermal insulation of the different components of the heating assembly.

The method for manufacturing the heating assembly may furthermore comprise bonding the temperature sensor layer on the heating layer, thereby forming a first stack. This may provide a stable heating assembly, wherein different electrically isolating substrate layers are bonded together. This may allow the formation of a stable first stack of the heating layer and the temperature sensor layer. The first stack therefore may comprise the heating layer and the temperature sensor layer being bonded together.

The method of manufacturing the heating assembly may comprise one or both of:
arranging a first adhesive layer on the first substrate layer for attachment between the first substrate layer and the heating element, and
arranging a second adhesive layer on the second substrate layer for attachment between the second substrate layer and the electrical contacts of the temperature sensor.

This may allow stable attachment of the heating element to the first substrate layer. This may allow stable attachment of the electrical contacts of the temperature sensor to the second substrate layer. Alternatively, the first substrate layer comprises Pyralux. Then the heating element can be arranged directly on the first substrate. The heating element may then be bonded directly to the first substrate. This may not require the presence of a first adhesive layer on the first substrate.

The method may further comprise arranging a third adhesive layer on the side of the second substrate layer being opposite to the electrical contacts of the temperature sensor. The temperature sensor layer and the heating layer may be bonded together via the third adhesive layer, thereby forming the first stack.

This may allow stable bonding of the temperature sensor layer to the heating layer via the third adhesive layer.

The bonding may comprise heating and applying pressure to the temperature sensor layer and the heating layer. The bonding may comprise applying a pressure of 1 kilogram/square meter at a temperature between 250 degrees Celsius to 360 degrees Celsius. The bonding may be performed for a duration between 5 minutes to 20 minutes, preferably 12 minutes. Preferably, the temperature sensor layer and the heating layer may be bonded together by applying between 0.05 kg/cm² to 1.2 kg/cm², preferably 0.1 kg/cm² to 1 kg/cm² of pressure at 340 degrees Celsius during 5 minutes to 20 minutes, preferably 12 minutes. The pressure may be 1 kg/cm², 0.1 kg/cm² or 0.5 kg/cm². The different layers may be bonded together by using a hot press device.

This may allow an easy bonding of the heating layer and the temperature sensor layer. This may allow a reliable bonding of the heating layer and the temperature sensor layer.

The method for manufacturing the heating assembly may furthermore comprise the method step of arranging a third substrate layer at least partly covering the temperature sensor layer on the heating layer, wherein the third substrate layer is an electrically isolating substrate layer.

The term ‘covering’ or ‘cover’ may mean that the third substrate layer has the substantial same surface size as the second substrate layer so that the third substrate layer can be placed on the second substrate layer in a way that the surface area of the second substrate layer facing the third substrate layer is substantially overlapped by the third substrate layer.

In case a third substrate layer is arranged covering a second substrate layer, the surface size of the third substrate layer may be at least 90% of the surface area of the second substrate layer, preferably the surface size of the third substrate layer may be at least 80% of the surface area of the second substrate layer, more preferably the surface size of the third substrate layer may be at least 70% of the surface area of the second substrate layer, most preferably the surface size of the third substrate layer may be at least 60% of the surface area of the second substrate layer.

Providing a third substrate layer on top of the heating layer and the temperature sensor layer may make manufacturing easier. In particular, bonding the heating layer and the temperature sensor layer may require application of pressure and high temperature in a hot melt press. The second adhesive may evenly applied on the whole surface of the second substrate layer. After attachment of the electrical contacts of the temperature sensor on the second substrate layer via the second adhesive, the electrical contacts may only occupy a limited area on the second substrate layer. Therefore, second adhesive may get in contact with the surface of the hot melt press, creating significant difficulties during the assembly process. The third substrate layer may prevent any contact between the second adhesive and the surface of the hot melt press.

The third substrate layer may comprise at least one through hole. The through hole may provide electrical contact between the electrical contacts of the temperature sensor layer and the temperature sensor. Preferably, the third substrate layer may comprise two through holes for providing electrical contact to two sensor contacts of the temperature sensor.

The method may further comprise arranging a fourth adhesive layer on the electrical contacts of the temperature sensor. The fourth adhesive layer may be for attachment of the temperature sensor layer to the third substrate layer. The fourth adhesive layer may comprise an adhesive layer through hole for providing electrical contact between the electrical contacts of the temperature sensor layer and the temperature sensor. The adhesive layer through hole may be aligned with the through hole in the third substrate layer to allow an electrical contact between the electrical contacts provided on the temperature sensor layer and the temperature sensor through the fourth adhesive layer and the third substrate layer.

The method for manufacturing the heating assembly may furthermore comprise bonding the third substrate layer to the temperature sensor layer on the heating layer, thereby forming a second stack. The second stack therefore may comprise the heating layer, temperature sensor layer and the third substrate layer being bonded together.

Preferably, the third substrate layer may be bonded to the temperature sensor layer on the heating layer via the fourth adhesive layer, thereby forming the second stack.

Bonding the third substrate layer to the temperature sensor layer on the heating layer may provide a stable and reliable connection between the different layers of the heating assembly.

The method for manufacturing the heating assembly may further comprise providing a heat conductive tube. The heat conductive tube may be a metal tube, preferably a stainless-steel tube. Alternatively, the tube may be a ceramic tube.

The method for manufacturing the heating assembly may comprise the steps of arranging the heating layer around the heat conductive tube. Preferably, one of the first stack or the second stack may be arranged around the heat conductive tube.

The tube may define a tubular shape of the heating assembly. The tube may define a tubular shape of the heating assembly when the heating layer is arranged around the heat conductive tube. The tube may define a tubular shape of the heating assembly when one of the first stack or the second stack are arranged around the heat conductive tube. A hot press device may be employed for arranging and bonding one of the first stack or second stack to the heat conductive tube. The hot press device may include a clamping device. The clamping device may be configured to apply pressure to the assembly of the heat conductive tube and one of the first stack or second stack.

The method of manufacturing the heating assembly may comprise the method step of rolling one of the first stack or the second stack around the tube. Preferably one of the first stack or the second stack are rolled around the tube one time. The outer diameter of the tube may correspond to the inner diameter of the first substrate layer of one of the first stack or the second stack after the first stack or the second stack have been rolled around the heat conductive tube.

Forming one of the first stack or the second stack and subsequently rolling the stack around the heat conductive tube may provide an easy method of manufacturing the heating assembly. Rolling one of the first stack or the second stack around the heat conductive tube may provide an easy manufacturing step. Rolling one of the first stack or the second stack around the heat conductive tube one time may be easier to carry out than former methods for manufacturing a heating assembly, wherein one continuous electrically isolated substrate layer containing both the heating element and the electrical contacts of the temperature sensor are wrapped around the tube two times.

This method for manufacturing the heating assembly may further comprise arranging a fifth adhesive layer on the heat conductive tube. The method may comprise bonding the heat conductive tube to one of the first stack or the second stack via the fifth adhesive layer.

This may provide a reliable bonding between the heat conductive tube and one of the first stack or the second stack.

The first substrate layer may comprise Pyralux. The first substrate layer may then directly be bonded to the heat conductive tube. This may not require the presence of a fifth adhesive layer on the heat conductive tube. Bonding the first substrate layer directly to the heat conductive tubes requires applying pressure. This method step does not require heating.

The method for manufacturing the heating assembly may furthermore comprise the step of attaching a temperature sensor to one of the first stack or the second stack. Preferably, the step of attaching the temperature sensor may comprise connecting the temperature sensor to the electrical contacts of the temperature sensor layer.

The method for manufacturing the heating assembly may further comprise firstly arranging one of the first stack or the second stack around the heat conductive tube and subsequently attaching the temperature sensor to the electrical contacts of the temperature sensor layer.

The temperature sensor may be arranged on the second substrate layer if the temperature sensor is attached to the first stack. The temperature sensor may be arranged on the third substrate layer if the temperature sensor is attached to the second stack.

This may provide an easy method of manufacturing a tubular shaped heating assembly including a heating element and electrical contacts contacting the temperature sensor.

The heat conductive tube may define a cavity for receiving an aerosol-generating article. The aerosol-generating article may be heated by the heat conductive tube. The heating element of the heating assembly may be configured to heat the heat conductive tube. The temperature sensor may be configured to determine a temperature of one or both of the heating element and the heat conductive tube.

The method for manufacturing the heating assembly may comprise the further method step of arranging a heat shrink layer around the temperature sensor. The heat shrink layer may be arranged around the tubular shaped assembly of the heat conductive tube and one of the first stack or second stack wrapped around the tube.

The heat shrink layer may be configured to shrink when heated. The heat shrink layer may securely hold the heat conductive tube, the temperature sensor and one of the first stack or the second stack together. The heat shrink layer may be configured to apply a uniform inward pressure to the heating assembly. The heat shrink layer may improve the contact between one or both of the heat conductive tube and one of the first stack or the second stack. The heat shrink layer may hold most or all components of the heating assembly tightly together. The heat shrink layer may be employed to replace the adhesive layers described herein. Alternatively, the heat shrink layer may be employed in addition to the adhesive layers described herein.

The thickness of the heat shrink layer may be between 100 micrometers and 300 micrometers, preferably around 180 micrometers.

The heat shrink layer may be made of polyether ether ketone (PEEK). The heat shrink layer may be made of or comprise one or more of Teflon and polytetrafluoroethylene (PTFE).

Surrounding the heat shrink layer, a thermally insulating layer may be provided. The thermal insulating layer is preferably made of aerogel.

One or more of the first substrate layer, the second substrate layer and the third substrate layer may have a thickness of between 10 micrometers and 50 micrometers, preferably between 20 micrometers and 30 micrometers, more preferably around 25 micrometers.

The heat conductive tube, when preferably made of stainless-steel, may have a thickness of between 20 micrometers and 60 micrometers, preferably between 30 micrometers and 50 micrometers, more preferably around 40 micrometers.

The heating element may comprise a resistive heater. The heating element may comprise a heating track. The heating element may be a heating track. The heating tracks may be configured to generate heat. The heating tracks may be electrically resistive heating tracks.

The heating tracks may be made from stainless-steel. The heating tracks may be made from stainless-steel at about 50 micrometers thickness. The heating tracks may be preferably made from stainless-steel at about 25 micrometers thickness. The heating tracks may be made from inconel at about 50.8 micrometers thickness. The heating tracks may be made from inconel at about 25.4 micrometers thickness. The heating tracks may be made from copper at about 35 micrometers thickness. Inconel may be an oxidation-corrosion-resistant alloy including nickel as a main component and chromium as a further component. The heating tracks may be made from nickel at about 12 micrometers thickness. The heating tracks may be made from brass at about 25 micrometers thickness.

The heating element, preferably the heating tracks, may be printed in the first substrate layer. The heating tracks may be photo-printed on the first substrate layer.

Preferably, the heating tracks are formed via lamination of a metal layer to the first substrate layer. The metal layer may be structured by a photolithographic process. The photolithographic process may involve the formation of a photoresist one the metal layer. The photoresist may be developed in order to form a structured photoresist layer. The structured photoresist layer may define the structure of the heating tracks. The heating tracks of the heating element may be formed via chemical etching through the structured photoresist.

The heating tracks may be centrally arranged on the first substrate layer. The heating tracks may have a bent shape. The heating tracks may have a curved shape. The heating tracks may have a zigzag shape. This heating tracks may have a winding shape.

One or more of the first substrate layer, the second substrate layer and the third substrate layer may comprise a polyamide, Pyralux or polyimide film. Any of the substrate layers may be made from polyimide or polyamide. The substrate layers may be configured to withstand between 220 degrees Celsius and 320 degrees Celsius, preferably between 240 degrees Celsius and 300 degrees Celsius, preferably around 280 degrees Celsius. Any of the substrate layers may be made from Pyralux.

One or more of the first adhesive layer, the second adhesive layer, the third adhesive layer, the fourth adhesive layer or the fifth adhesive layer may have a thickness of between 2 micrometers and 50 micrometers, preferably between 3 micrometers and 7 micrometers, more preferably around 5 micrometers. The fifth adhesive layer may have a thickness of around 20 micrometers to 30 micrometers, preferably a thickness of 25 micrometers. This may ensure a reliable bonding of the heat conductive tube to the one of the first stack or second stack. This may improve the heat efficiency.

One or more of the first adhesive layer, the second adhesive layer, the third adhesive layer, the fourth adhesive layer or the fifth adhesive layer may be silicon-based adhesive layer. The adhesive layer may comprise one or both of PEEK-based adhesives and acrylic adhesives.

The temperature sensor may be a negative temperature coefficient sensor (NTC), a Pt100 or preferably a Pt1000 temperature sensor.

The temperature sensor may be attached to one of the first stack or the second stack via welding or soldering to the electrical contacts on the second substrate layer.

The invention furthermore may provide a method for manufacturing an aerosol-generating device. The aerosol-generating device may comprise a cavity for receiving an aerosol-generating article. The aerosol-generating article may comprise aerosol-forming substrate. The cavity may be located in a housing of the aerosol-generating device. The method may comprise the method step of manufacturing the heating assembly as described herein. The method furthermore may comprise the step of providing a housing for the aerosol-generating device. The method may comprise the method step of arranging the heating assembly in the housing, thereby forming the cavity.

Another embodiment of the invention provides a method for manufacturing an aerosol-generating device. The aerosol-generating device comprises a cavity for receiving an aerosol-generating article. The aerosol-generating article comprises aerosol-forming substrate. The cavity is located in a housing of the aerosol-generating device. The method comprises the method step of manufacturing the heating assembly as described herein. The method furthermore comprises the method step of providing a housing for the aerosol-generating device and arranging the heating assembly in the housing, thereby forming the cavity.

This method for manufacturing an aerosol-generating device provides a reliable and easy method of forming a heating assembly as a separate component of the aerosol-generating device. The complete heating assembly can then be arranged in the housing of the aerosol-generating device. This may form the cavity for receiving the aerosol-generating article in the device.

A sidewall of the cavity may be formed by the heat conductive tube of the heating assembly. This may ensure a reliable and uniform heating of the aerosol-generating article received in the cavity via the heat conductive tube.

The method for manufacturing the aerosol-generating device may furthermore comprise the method step of providing control circuitry. The control circuitry may be configured for controlling the temperature of the heating element based on temperature information on the heating element determined by the temperature sensor. The control circuitry may be connected to the heating element and the temperature sensor.

In all of the aspects of the disclosure, the heating element may comprise an electrically resistive material. Suitable electrically resistive materials include but are not limited to: semiconductors such as doped ceramics, electrically “conductive” ceramics (such as, for example, molybdenum disilicide), carbon, graphite, metals, metal alloys and composite materials made of a ceramic material and a metallic material. Such composite materials may comprise doped or undoped ceramics.

As described, in any of the aspects of the disclosure, the heating element may comprise an external heating element, where “external” refers to the aerosol-forming substrate. An external heating element may take any suitable form. For example, an external heating element may take the form of one or more flexible heating foils or heating tracks on a dielectric substrate, such as polyimide. The dielectric substrate is the first substrate layer. The flexible heating foils or heating tracks can be shaped to conform to the perimeter of the cavity. Alternatively, an external heating element may take the form of a metallic grid or grids, a flexible printed circuit board, a molded interconnect device (MID), ceramic heater, flexible carbon fibre heater or may be formed using a coating technique, such as plasma vapour deposition, on the suitable shaped first substrate layer. An external heating element may also be formed using a metal having a defined relationship between temperature and resistivity. In such an exemplary device, the metal may be formed as a track between the first substrate layer and the second substrate layer. An external heating element formed in this manner may be used to both heat and monitor the temperature of the external heating element during operation.

The heating element advantageously heats the aerosol-forming substrate by means of conduction. Alternatively, the heat from either an internal or external heating element may be conducted to the substrate by means of a heat conductive element.

During operation, the aerosol-forming substrate may be completely contained within the aerosol-generating device. In that case, a user may puff on a mouthpiece of the aerosol-generating device. Alternatively, during operation a smoking article containing the aerosol-forming substrate may be partially contained within the aerosol-generating device. In that case, the user may puff directly on the smoking article.

The heating element may be configured as an induction heating element. The induction heating element may comprise an induction coil and a susceptor. In general, a susceptor is a material that is capable of generating heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate. When an induction heating element is employed, the induction heating element may be configured as an external heater as described herein. If the induction heating element is configured as an external heating element, the susceptor element is preferably configured as a cylindrical susceptor at least partly surrounding the cavity. The heating tracks described herein may be configured as a susceptor. The susceptor may be arranged between the first substrate layer and the second substrate layer. The second portion of the substrate layer may be surrounded by the induction coil. The susceptor as well as the induction coil may be part of the heating assembly.

Preferably, the method of manufacturing the aerosol-generating device comprises a method step of providing a power supply configured to supply power to the one or both of the heating element and the heating assembly. The power supply preferably comprises a power source. Preferably, the power source is a battery, such as a lithium ion battery. As an alternative, the power source may be another form of charge storage device such as a capacitor. The power source may require recharging. For example, the power source may have sufficient capacity to allow for the continuous generation of aerosol for a period of around six minutes or for a period that is a multiple of six minutes. In another example, the power source may have sufficient capacity to allow for a predetermined number of puffs or discrete activations of the heating assembly.

As used herein, the term “aerosol-forming substrate” refers to a substrate capable of releasing volatile compounds that can form an aerosol. The volatile compounds may be released by heating or combusting the aerosol-forming substrate. As an alternative to heating or combustion, in some cases, volatile compounds may be released by a chemical reaction or by a mechanical stimulus, such as ultrasound. The aerosol-forming substrate may be solid or liquid or may comprise both solid and liquid components. An aerosol-forming substrate may be part of an aerosol-generating article.

As used herein, the term “aerosol-generating article” refers to an article comprising an aerosol-forming substrate that is capable of releasing volatile compounds that can form an aerosol. An aerosol-generating article may be disposable.

As used herein, the term “aerosol-generating device” refers to a device that interacts with an aerosol-forming substrate to generate an aerosol. An aerosol-generating device may interact with one or both of an aerosol-generating article comprising an aerosol-forming substrate, and a cartridge comprising an aerosol-forming substrate. In some examples, the aerosol-generating device may heat the aerosol-forming substrate to facilitate release of volatile compounds from the substrate. An electrically operated aerosol-generating device may comprise an atomiser, such as an electric heater, to heat the aerosol-forming substrate to form an aerosol.

As used herein, the term “aerosol-generating system” refers to the combination of an aerosol-generating device with an aerosol-forming substrate. When the aerosol-forming substrate forms part of an aerosol-generating article, the aerosol-generating system refers to the combination of the aerosol-generating device with the aerosol-generating article. In the aerosol-generating system, the aerosol-forming substrate and the aerosol-generating device cooperate to generate an aerosol.

Features described in relation to one embodiment may equally be applied to other embodiments of the invention.

The invention will be further described, by way of example only, with reference to the accompanying drawings in which:

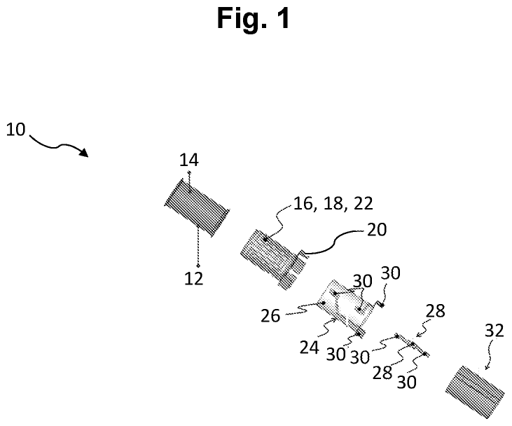

FIG. 1 shows the heating assembly including the heat conductive tube, the heating layer and the temperature sensor layer;

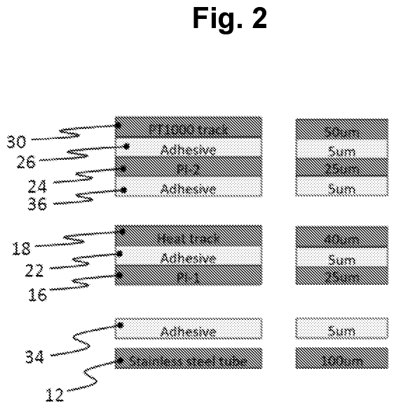

FIG. 2 shows different layers making up the heating assembly;

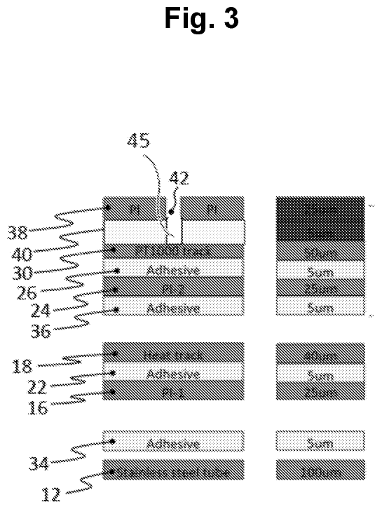

FIG. 3 shows different layers making up the heating assembly including a third insulating layer; and

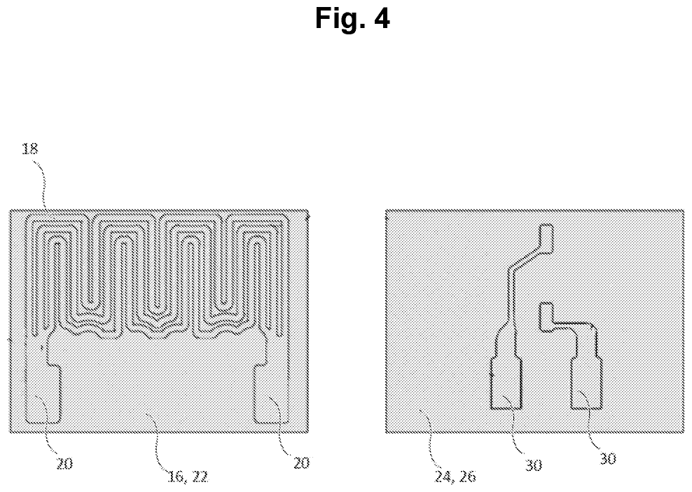

FIG. 4 depicts a top view of the heating layer and the temperature sensor layer before they have been bonded together in order to form the first stack;

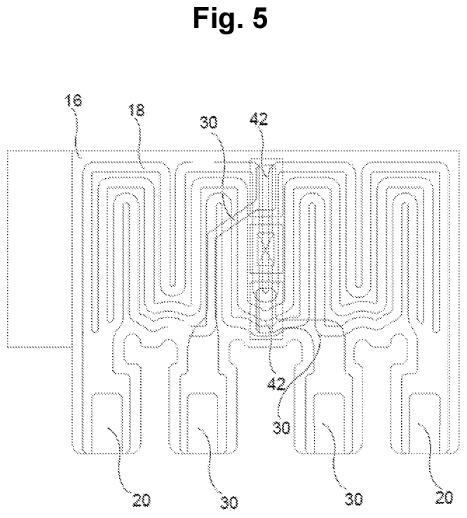

FIG. 5 shows a top view of the second stack formed via bonding together the heating layer and the temperature sensor layer shown in FIG. 4 with a third substrate layer.

In the following the same elements are marked with the same reference numerals throughout all the figures.

FIG. 1 shows a heating assembly 10. All the components of the heating assembly are already rolled up in order to provide tubular components. The heating assembly 10 comprises a heat conductive tube, such as a stainless-steel tube 12. The stainless-steel tube 12 forms the inner layer of the heating assembly 10. The stainless-steel tube 12 is tubular. The stainless-steel tube 12 forms a cavity 14 such that an aerosol-generating article comprising aerosol forming substrate can be placed in the cavity 14 to heat the aerosol-forming substrate and to create an inhalable aerosol.

FIG. 1 further shows a first substrate layer 16. On top of the first substrate layer 16, a heating element 18 in the form of heating tracks is arranged. Electrical heater contacts 20 of the heating element 18 are also shown in FIG. 1. On the first substrate layer 16, a first adhesive layer 22 is arranged for an attachment between the first substrate layer 16 and the heating element 18. Additionally, the surface area of the first substrate layer 16 not covered with the heating element 18 may be attached to the second substrate layer 24 via the first adhesive layer 22.

FIG. 1 further shows the second substrate layer 24. On the second substrate layer 24, a second adhesive layer 26 is arranged. The second adhesive layer 26 has the function of enabling an attachment between the second substrate layer 24 and electrical contacts of a temperature sensor 28. The second adhesive layer 26 further facilitates the attachment between the second substrate layer 24 and sensor contacts 30 of the temperature sensor 28. Finally, the second adhesive layer 26 facilitates the attachment between the second substrate layer 24 and an optional third substrate layer 38. An optional third substrate layer is arranged over the temperature sensor layer. The third substrate layer is not depicted in FIG. 1. Finally, a heat shrink layer 32 is placed over the heating assembly 10. Heating of the heat shrink layer 32 facilitates a secure holding of all components of the heating assembly 10.

In a first step, a heating layer is formed by arranging the heating element 18 on the first substrate layer 16 via the first adhesive layer 22. A temperature sensor layer is formed by arranging the electrical contacts 30 of the temperature sensor on the second substrate layer 24 via the second adhesive layer 26. The temperature sensor layer can be bonded to the heating layer via a hot press method, applying pressure and temperature, thereby forming the first stack. The first stack may be a flat stack before being wrapped around the conductive tube. The first stack subsequently may be wrapped around the heat conductive stainless-steel tube 12 in order to provide a tubular form. Subsequently, the temperature sensor 28 may be attached to the first stack, wrapped around the heat conductive tube 12. Preferably, the temperature sensor 28 may be connected to the electrical contacts of the sensor 30 on the temperature sensor layer via the sensor contacts 30 located on the temperature sensor 28.

Alternatively, the third substrate layer not shown in FIG. 1 may be bonded to the heating layer and the temperature sensor layer in order to provide the second stack. This second stack then may be wrapped around the stainless-steel tube 12. In this alternative method for manufacturing the heating assembly, the temperature sensor 28 then may be attached to the electrical contacts 30 of the temperature sensor layer through the through hole in the third substrate layer in order to be connected to the second stack.

FIG. 2 shows the layers of the heating assembly 10 in more detail. The inner layer is formed by the stainless-steel tube 12. A fifth adhesive layer 34 is provided to connect the stainless-steel tube 12 with the first substrate layer 16. As a next layer, the heating element 18 is arranged on the first substrate layer 16 via the first adhesive layer 22. This provides the heating layer. Between the heating element 18 and the second substrate layer 24, a third adhesive layer 36 is provided for attachment to the heating layer. Finally, the electrical contacts 30 of the temperature sensor are arranged on the second substrate layer 24 via the second adhesive layer 26. This provides the temperature sensor layer. Bonding the heating layer to the temperature sensor layer by the third adhesive layer 36 provides the first stack. FIG. 2 further shows the preferred thicknesses of all layers.

FIG. 3 shows the additional placement of a third substrate layer 38 over the temperature sensor 28 via a fourth adhesive layer 40. In the third substrate layer 38 at least one through hole 42 is provided to enable sensor contacts 30 to be contacted through the third substrate layer 38 for attachment and electrically contacting of the temperature sensor 28. Additionally, an adhesive layer through hole 45 is present in the fourth adhesive layer. This adhesive layer through hole allows to contact the sensor contacts 30 of the temperature sensor layer for contacting the temperature sensor 28 through the fourth adhesive layer. FIG. 3 further shows the preferred thicknesses of all layers.

FIG. 4 depicts on the left-hand side the heating layer comprising the first substrate 16, with the first adhesive layer 22. The heating element 18 is attached via the first adhesive layer 22 to the first substrate 16. The heating element 18 comprises tracks. The heating element 18 also includes electrical heater contacts 20. On the right-hand side of FIG. 4 the temperature sensor layer is shown. The temperature sensor layer includes the second substrate 24 with the second adhesive layer 26. Electrical contacts 30 of the temperature sensor are attached to the second substrate 24 via the use of layer 26.

FIG. 5 shows a top view of the second stack. The second stack is formed via bonding together the heating layer and the temperature sensor layer shown in FIG. 4 and additionally bonding the third substrate layer to the heating layer and the temperature sensor layer. For the sake of clarity, neither the second substrate layer nor the third substrate layer are shown. Only the first substrate layer 16 is shown. FIG. 5 furthermore shows the heating tracks of the heating element 18 with the electrical heater contacts 20, the electrical contacts 30 of the temperature sensor layer and the though holes 42 of the third substrate layer. The heating tracks of the heating element 18 are depicted in FIG. 5. Two heater contacts 20 are provided to enable the supply of electrical energy to the heating element 18. Further, two electrical connections 30 of the temperature sensor are provided for electrically contacting the temperature sensor 28. Two through holes 45 are present on the third substrate layer (third substrate layer not shown in FIG. 5). These through holes allows the contacting of the electrical contacts of the temperature sensor layer through the third substrate layer.

1-20. (canceled)

21. A method for manufacturing a heating assembly for an aerosol-generating device, the method comprising the steps of:
providing a first substrate layer, the first substrate layer being an electrically isolating substrate layer,
arranging a heating element on the first substrate layer, thereby forming a heating layer,
providing a second substrate layer, the second substrate layer being an electrically isolating substrate layer,
arranging electrical contacts of a temperature sensor on the second substrate layer, thereby forming a temperature sensor layer,
arranging the temperature sensor layer on the heating layer, further comprising arranging a third substrate layer at least partly covering the temperature sensor layer on the heating layer, the third substrate layer being an electrically isolating substrate layer, wherein the third substrate layer comprises at least one through hole for electrical contact between the electrical contacts and the temperature sensor.

22. The method according to claim 21, wherein the method further comprises bonding the temperature sensor layer on the heating layer, thereby forming a first stack.

23. The method according to claim 21, comprising one or both of:
arranging a first adhesive layer on the first substrate layer for attachment between the first substrate layer and the heating element, and
arranging a second adhesive layer on the second substrate layer for attachment between the second substrate layer and the electrical contacts of the temperature sensor.

24. The method according to claim 22, wherein the method further comprises arranging a third adhesive layer on a side of the second substrate layer being opposite to the electrical contacts of the temperature sensor, wherein the temperature sensor layer and the heating layer are bonded together via the third adhesive layer, thereby forming the first stack.

25. The method according to claim 24, wherein the bonding comprises heating and applying pressure to the temperature sensor layer and the heating layer, wherein the bonding comprises applying a pressure of between 0.05 kg/cm² to 1.2 kg/cm², or 0.1 kg/cm² to 1 kg/cm² at a temperature between 250 degree Celsius to 360 degree Celsius.

26. The method according to claim 22, wherein the method further comprises arranging a fourth adhesive layer on the electrical contacts of the temperature sensor for attachment of the temperature sensor layer to the third substrate layer.

27. The method according to claim 26, wherein the method further comprises bonding the third substrate layer to the temperature sensor layer on the heating layer, thereby forming a second stack, wherein the method comprises bonding the third substrate layer to the temperature sensor layer on the heating layer via the fourth adhesive layer.

28. The method according to claim 27, wherein the method further comprises providing a heat conductive tube, and wherein the heating layer is arranged around the heat conductive tube.

29. The method according to claim 28, wherein one of the first stack or the second stack are rolled around the tube, and wherein one of the first stack or the second stack are rolled around the tube only one time.

30. The method according to claim 28, wherein the method further comprises arranging a fifth adhesive layer on the heat conductive tube, and wherein the method comprises bonding the heat conductive tube to one of the first stack or the second stack via the fifth adhesive layer.

31. The method according to claim 28, wherein the first substrate layer comprises Pyralux, and wherein the heat conductive tube is directly bonded to the first substrate layer.

32. The method according to claim 27, wherein the method further comprises attaching a temperature sensor to one of the first stack or the second stack, wherein the method comprises connecting the temperature sensor to the electrical contacts of the temperature sensor layer.

33. The method according to claim 40, wherein the method further comprises firstly arranging one of the first stack or the second stack around the heat conductive tube, and wherein subsequently the temperature sensor is attached to the electrical contacts of the temperature sensor layer.

34. The method according to claim 32, wherein the method further comprises arranging a heat shrink layer around the temperature sensor.

35. A method for manufacturing an aerosol-generating device, the aerosol-generating device comprising a cavity for receiving an aerosol-generating article, the cavity being located in a housing, the method comprising the steps of:
manufacturing a heating assembly according to a method of claim 21,
providing a housing for the aerosol-generating device, and
arranging the heating assembly in the housing, thereby forming the cavity.

36. The method according to claim 35, wherein a sidewall of the cavity is formed by a heat conductive tube of the heating assembly.

37. The method according to claim 35, further comprising providing control circuitry configured for controlling a temperature of the heating element based on temperature information on the heating element determined by the temperature sensor, wherein the control circuitry is connected to the heating element and the temperature sensor.

38. A heating assembly manufactured with the method of claim 21.

39. An aerosol-generating device manufactured with the method of claim 35.

40. The method according to claim 27, wherein the method further comprises providing a heat conductive tube, and wherein the heating layer is arranged around the heat conductive tube, and wherein one of the first stack or the second stack are arranged around the heat conductive tube.
